(19) United States
(12) Patent Application Publication
(10) Pub. No.: US 2017/0017734 A1
(43) Pub. Date: Jan. 19, 2017

(54) Crowdsourced Event Reporting and Reconstruction

(71) Applicant: Ford Global Technologies, LLC, Dearborn, MI (US)

(72) Inventors: Alexander Groh, Detroit, MI (US); John William Schmotzer, Canton, MI (US); Pol Llado, Canton, MI (US); Ali Hassani, Ann Arbor, MI (US); Dylan Verster, Northville, MI (US); Arun Dutta, Ann Arbor, MI (US)

(21) Appl. No.: 14/799,862

(22) Filed: Jul. 15, 2015

(51) Int. Cl. G06F 17/50

(52) U.S. Cl. CPC G06F 17/5009

(57) ABSTRACT

A crowdsourcing server receives sensor data from vehicles within a vicinity of a location of an event at a time of the event in response to the vehicles being notified of an occurrence of the event. The sensor data includes sensor data of the vehicles sensed at the time of the event. The crowdsourcing server associates the sensor data with the event. The event can be reconstructed using the sensor data associated with the event.

### TECHNICAL FIELD

The present disclosure relates to automotive crowdsourced event reporting and reconstruction using connected vehicles and connected transportation infrastructure.

### BACKGROUND

Vehicles are headed towards cloud connected, sensor-rich environments cooperatively employing vehicle to vehicle (V2V) and vehicle to transportation system infrastructure (V2I) communications.

### SUMMARY

A method includes receiving, by a crowdsourcing server, sensor data from vehicles within a vicinity of a location of an event at a time of the event in response to the vehicles being notified of an occurrence of the event. The sensor data includes sensor data of the vehicles sensed at the time of the event.

The sensor data may include sensor data of the vehicles sensed prior to, during, and after the event.

The method may further include receiving, by the crowdsourcing server, a notification of the occurrence of the event and associating, by the crowdsourcing server, the sensor data with the event.

The method may further include reconstructing the event using the sensor data associated with the event.

The method may further include notifying, by the crowdsourcing server, a recipient of a reconstructed version of the event. The recipient may be at least one of the vehicles.

The method may further include receiving, by the crowdsourcing server, sensor data from transportation system infrastructure within the vicinity of the location of the event. The sensor data of the transportation system infrastructure includes sensor data of the transportation system infrastructure sensed at the time of the event.

The event may or may not involve any of the vehicles. The event may be a collision involving at least one of the vehicles.

The method may further include notifying the crowdsourcing server of the occurrence of the event, and upon the crowdsourcing server being notified of the occurrence of the event, triggering, by the crowdsourcing server, the vehicles to provide the sensor data to the crowdsourcing server.

A system includes a crowdsourcing server configured to receive sensor data from vehicles within a vicinity of a location of an event at a time of the event in response to the vehicles being notified of an occurrence of the event. The sensor data includes sensor data of the vehicles sensed at the time of the event.

Another method includes detecting, by a first vehicle, an occurrence of an event and notifying, by the first vehicle, a crowdsourcing server and other vehicles within a vicinity of the event at a time of the event of the occurrence of the event. This method further includes transmitting, from the other vehicles, sensor data of the other vehicles sensed at the time of the event to the crowdsourcing server.

This method may further include transmitting, by the first vehicle, sensor data of the first vehicle sensed at the time of the event to the crowdsourcing server.

The sensor data of a given one of the vehicles includes sensor data indicative of at least one of an external environment of the given one of the vehicles, an operating condition of the given one of the vehicles, and a location of the given one of the vehicles.

This method may further include notifying, by the first vehicle, transportation system infrastructure units within the vicinity of the event of the occurrence of the event and transmitting, from the transportation system infrastructure units, sensor data of the transportation system infrastructure units sensed at the time of the event to the crowdsourcing server. The sensor data of the transportation system infrastructure units includes sensor data indicative of external environments of the transportation system infrastructure units.

This method may further include associating, by the crowdsourcing server, the sensor data with the event and reconstructing the event using the sensor data associated with the event.

The event may or may not involve any of the vehicles. The event may be a collision involving one of (i) the first vehicle and none of the other vehicles and (ii) the first vehicle and at least one of the other vehicles.

### BRIEF DESCRIPTION OF THE DRAWINGS

FIG. 1 illustrates a block diagram of an automotive crowdsourced event reporting and reconstruction system;

FIG. 2 illustrates a flowchart depicting operation of the automotive crowdsourced event reporting and reconstruction system; and

FIG. 3 illustrates a schematic of the automotive crowdsourced event reporting and reconstruction system employing vehicles involved in a collision, nearby vehicles, and nearby transportation system infrastructure.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

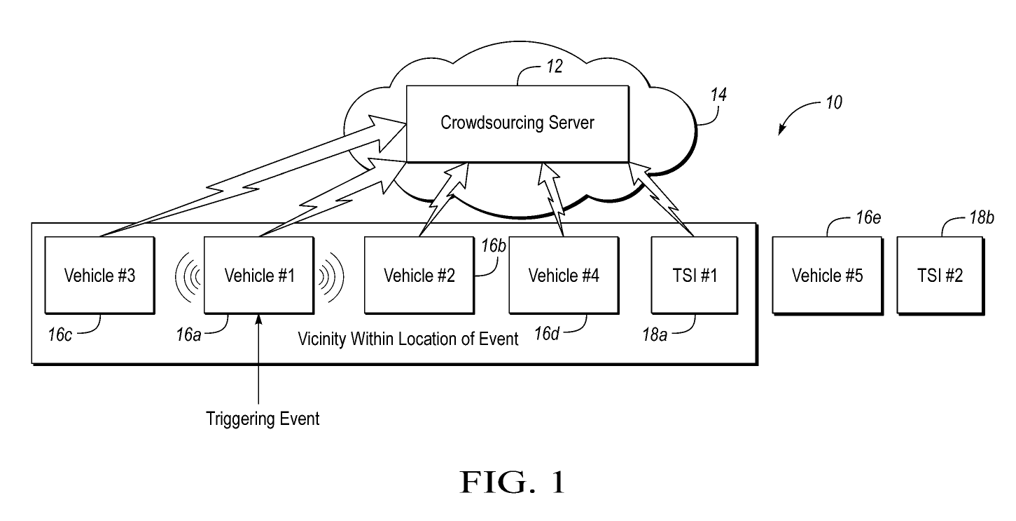

Referring now to FIG. 1, a block diagram of an automotive crowdsourced event reporting and reconstruction system 10 is shown. After a vehicle collision, it is often difficult to determine who was at fault. System 10 utilizes existing automotive and connected infrastructure technologies to define a system which can provide crowdsourced data for assigning fault and for providing emergency responders with relevant information timely and accurately.

System 10 includes a crowdsourcing server 12 located in the cloud 14. Crowdsourcing server 12 is configured to receive wireless communications from vehicles such as vehicles 16a, 16b, 16c, 16d, and 16e and from transportation system infrastructure (TSI) units such as TSI units 18a and 18b. Vehicles 16 include sensors which can sense the external environment of the vehicles and operating conditions of the vehicles. Vehicle sensors which can sense the vehicle external environment include video cameras, range/radar/ultrasonic sensors, microphones, GPS receiver, etc. Vehicle sensors which can sense vehicle operating conditions include on-board sensors which collect vehicle operating data such as from the vehicle CAN including steering data, throttle position data, chassis acceleration data, etc. Vehicles 16 are configured to be able to wirelessly communicate their sensor data to crowdsourcing server 12.

TSI units 18 are adjacent the roadway and include sensors such as mounted video cameras. TSI units 18 are configured to wirelessly communicate their sensor data to crowdsourcing server 12.

In operation, upon the occurrence of a triggering event, vehicles 16 within the vicinity of the event at the time of the event are notified of the occurrence of the event. Vehicles 16 respond by uploading their sensor data to crowdsourcing server 12. The uploaded sensor data from a vehicle 16 is the sensor data of the vehicle sensed at the time of the event including just prior to, during, and just after the event (e.g., five seconds before and five seconds after the event). Crowdsourcing server 12 associates the uploaded sensor data with the event. In this way, crowdsourced event reporting occurs. The uploaded sensor data associated with the event can be analyzed to reconstruct the event. In this way, crowdsourced event reconstruction occurs.

Alternatively or additionally, TSI units 18 within the vicinity of the event at the time of the event are notified of the occurrence of the event. TSI units 18 respond by uploading their sensor data to crowdsourcing server 12. The uploaded sensor data from a TSI unit 18 is the sensor data of the TSI unit sensed at the time of the event including just prior to, during, and just after the event. Crowdsourcing server 12 associates this uploaded sensor data with the event.

The triggering event may or may not involve any of the vehicles. A triggering event involving one or more of vehicles 16 may be a vehicle collision. As indicated, determining liability in a vehicle collision involving multiple vehicles has always been difficult. System 10 solves this problem by employing the various sensor data of vehicles 16 and/or TSI units 18 to determine liability. Implementing a rolling save of sensor data of vehicles 16 and/or TSI units 18 and uploading this sensor data to crowdsourcing server 12 in the cloud 14 upon the occurrence of the vehicle collision enables a culpability determination to be made. In sum, triggering events or situations can be reconstructed digitally using the sensor data and replayed to ascertain accountability.

With reference to FIG. 1, the operation of system 10 for crowdsourced event reporting and reconstruction will be described in further detail. The described operation will assume that the triggering event is a collision involving first vehicle 16a. The operation commences with first vehicle 16a being involved in the collision. The collision may involve first vehicle 16a by itself or with any of the other vehicles 16 and/or with any other vehicles not shown in FIG. 1. For simplicity, it will be assumed that the collision just involves first vehicle 16a by itself

The act of the collision is a triggering event for system 10. Sensors of first vehicle 16a detect the first vehicle being in the collision. Detecting the collision triggers first vehicle 16a to upload its sensor data to crowdsourcing server 12. The sensor data includes, for instance, a notification that first vehicle 16a has been involved in a collision and GPS location information indicative of the location of first vehicle 16a at the time of the collision. As such, the GPS location information is also indicative of the location and time of the collision. The sensor data includes the sensor data sensed by the sensors of first vehicle 16a at the time of the collision (i.e., just prior to, during, and just after the collision). All together the sensor data uploaded from first vehicle 16a to crowdsourcing server 12 includes information regarding the location and time of the collision, the external environment of the first vehicle at the time of the collision, and operating conditions of the first vehicle at the time of the collision. Of course, instead of the transmission of the sensor data of first vehicle 16a from the first vehicle to crowdsourcing server 12 occurring contemporaneously with collision detection, the transmission can occur at a later time (hours, days) after the collision.

Detecting the collision also triggers first vehicle 16a to broadcast an alert flag. The alert flag is an alert that a triggering event has occurred. In this case, as the triggering event is a collision involving first vehicle 16a, the alert flag is a collision alert flag. For instance, the collision alert flag is indicative of the location and time of the collision. Crowdsourcing server 12 receives the collision alert flag broadcasted from first vehicle 16a. Crowdsourcing server 12 may be further or alternatively made aware of first vehicle 16a being involved in a collision from the collision alert flag from first vehicle 16a. In any case, crowdsourcing server 12 associates the collision alert flag and the sensor data uploaded from first vehicle 16a with an identifier uniquely associated with the collision event.

The broadcast of the collision alert flag from first vehicle 16a serves another purpose. The alert flag is a trigger to vehicles within the vicinity of the collision at the time of the collision to upload their sensor data sensed at the time of the collision to crowdsourcing server 12. As shown in FIG. 1, second, third, and fourth vehicles 16b, 16c, and 16d are within the vicinity of the collision at the time of the collision. For instance, second, third, and fourth vehicles 16b, 16c, and 16d are within the vicinity of the collision at the time of the collision by virtue of receiving the alert flag. As another example, second, third, and fourth vehicles 16b, 16c, and 16d are within the vicinity of the collision at the time of the collision from a comparison of their location with the location of the collision. Further, upon receiving the alert flag, crowdsourcing server 12 can broadcast the alert flag for receipt by vehicles 16 within the vicinity of the collision at the time of the collision. Vehicles 16 receiving the alert flag can push the alert flag to other vehicles using vehicle to vehicle (V2V) communication technology.

In any case, in response to receiving the alert flag and being within the vicinity of the collision at the time of the collision, second, third, and fourth vehicles 16b, 16c, and 16d upload their respective sensor data at the time of the collision (again, just prior to, during, and just after the collision) to crowdsourcing server 12. The sensor data from second vehicle 16b includes information regarding the location of the second vehicle at the time of the collision, the external environment of the second vehicle at the time of the collision, and operating conditions of the second vehicle at the time of the collision; the sensor data from third vehicle 16c includes information regarding the location of the third vehicle at the time of the collision, the external environment of the third vehicle at the time of the collision, and operating conditions of the third vehicle at the time of the collision; etc. The transmission of the sensor data from any of second, third, and fourth vehicles 16b, 16c, and 16d to crowdsourcing server 12 can occur contemporaneously with reception of the alert flag (i.e., at the time of the collision) or at a later time after reception of the alert flag (i.e., at a later time after the collision).

Crowdsourcing server 12 associates the sensor data uploaded from second, third, and fourth vehicles 16b, 16c, and 16d with the identifier uniquely associated with the collision event. The sensor data uploaded from first, second, third, and fourth vehicles 16a, 16b, 16c, and 16d is thereby all associated together with the identifier uniquely associated with the collision event. In this way, crowdsourced event reporting using multiple vehicles takes place. The multiple vehicles used for the crowdsourced event reporting include vehicles directly involved in the event (i.e., first vehicle 16a involved in the collision) and bystander vehicles which effectively act as witnesses to the event (i.e., second, third, and fourth vehicles 16b, 16c, and 16d).

As shown in FIG. 1, fifth vehicle 16e is not within the vicinity of the collision at the time of the collision. As such, fifth vehicle 16e does not receive the alert flag or, on the other hand, the fifth vehicle does receive the alert flag but is deemed to be too far away from the location collision at the time of the collision. As fifth vehicle 16a is not within the vicinity of the collision at the time of the collision, the fifth vehicle does not upload any of its sensor data for the collision. In this way, the sensor data associated by crowdsourcing server 12 with the collision event is not cluttered with non-relevant information.

The alert flag is also a trigger to TSI units within the vicinity of the collision at the time of the collision to upload their sensor data sensed at the time of the collision to crowdsourcing server 12. As shown in FIG. 1, first TSI unit 18a is within the vicinity of the collision at the time of the collision. Therefore, in response to receiving the alert flag broadcasted by first vehicle 16a, first TSI unit 18a uploads its respective sensor data at the time of the collision to crowdsourcing server 12. The sensor data from first TSI unit 18a includes information regarding the location of the first TSI unit and the external environment of the first TSI unit at the time of the collision. The transmission of the sensor data from first TSI unit 18a to crowdsourcing server 12 can occur contemporaneously with reception of the alert flag or at a later time after the collision.

Crowdsourcing server 12 associates the sensor data uploaded from first TSI unit 18a with the identifier uniquely associated with the collision event. The sensor data uploaded from the first, second, third, and fourth vehicles 16a, 16b, 16c, and 16d and first TSI unit 18a is thereby all associated together with the identifier uniquely associated with the collision event. In this way, crowdsourced event reporting using vehicles and TSI units takes place.

As shown in FIG. 1, second TSI unit 18b is not within the vicinity of the collision. As such, second TSI unit 18b does not upload any of its sensor data for the collision. In this way, again, the sensor data associated by crowdsourcing server 12 with the collision event is not cluttered with non-relevant information.

As noted, the described operation assumed that that the collision involves first vehicle 16a by itself In the case of the collision involving first vehicle 16a and other vehicles, the operation further includes the other vehicles uploading their sensor data to crowdsourcing server 12 in response to detecting the collision and transmitting their own collision alert flags.

The broadcasting of an event alert flag from first vehicle 16a, as well as from any of the other vehicles, for receipt by nearby vehicles can be done leveraging vehicle to vehicle (V2V) communication technology. In this way, the vehicle involved in an event such as a collision, i.e., first vehicle 16a, can communicate to the other vehicles that there has been a collision. As described, once an event flag has been triggered, other vehicles and connected TSI units within proximity to the collision upload relevant sensor data to crowdsourcing server 12 in the cloud 14. To increase the robustness of data transmission, one vehicle may transmit its relevant sensor data to another vehicle through V2V communications which then forwards this sensor data to crowdsourcing server 12.

Crowdsourcing server 12 associates all of the uploaded sensor data with the event. The uploaded sensor data can be analyzed to reconstruct the event. The analysis may be done by a third party or by crowdsourcing server 12. In any case, the crowdsourcing of information can lead to more complex and accurate analysis of events such as collisions with data previously unavailable. Eyewitness reports, post-crash interviews by police, and the like could potentially be made obsolete by system 10.

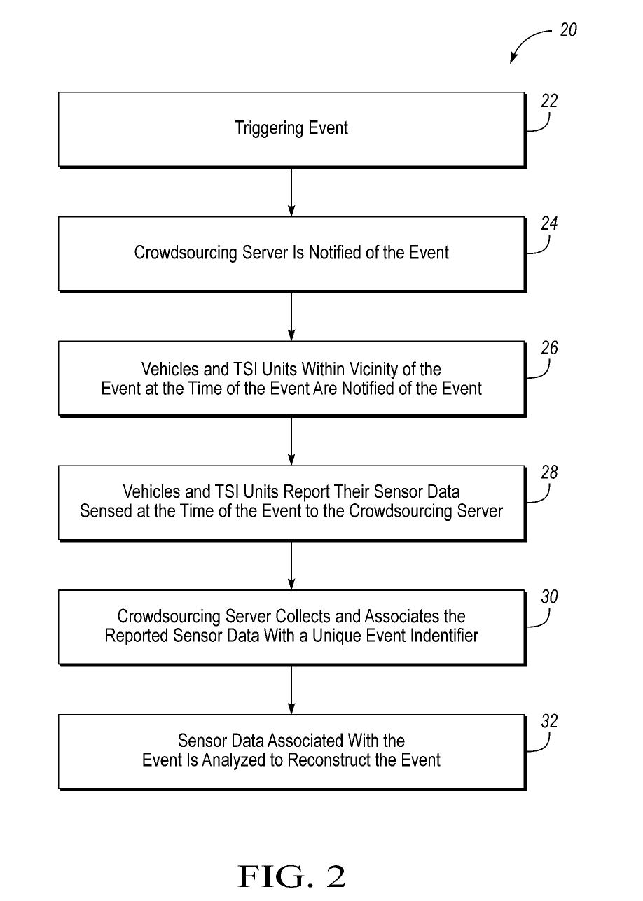

Referring now to FIG. 2, with continual reference to FIG. 1, a flowchart 20 depicting operation of system 10 is shown. The operation commences upon the occurrence of a triggering event as shown in block 22. Crowdsourcing server 12 is made aware of the location and time of the triggering event as indicated in block 24. Vehicles 16 and TSI units 18 within the vicinity of the event at the time of the event are immediately made aware of the event as indicated by block 26. These vehicles 16 and TSI units 18 respond by uploading their sensor data sensed at the time of the event to crowdsourcing server 12 as indicated in block 28. Crowdsourcing server 12 associates all of the uploaded sensor data with a unique triggering event identifier as indicated in block 30. The uploaded sensor data is analyzed by a third party or by crowdsourcing server 12 to reconstruct the triggering event as indicated in block 32. This analysis of reconstructing the triggering event may include determining the cause of the triggering event, responsibility of the parties involved in the triggering event, and damages caused by the triggering event.

The triggering event may be a collision involving one or more vehicles as described. However, the triggering event does not need to involve any of the vehicles nor does the triggering event need to be an automotive related event. For instance, the triggering event may be an event relating to defense and homeland security applications. The triggering event can take any of a diverse type of forms because system 10 is a crowdsourced surveillance tool that can capture an environment of interest at a time of interest. Anything that the sensor suite of vehicles can sense can be categorized as an event. As such, a triggering event does not need to involve any vehicle—all that matters is that relevant data for the event can be gathered from nearby vehicles.

An example of a diverse type of triggering event is a gunshot event. In operation, three vehicles sense a gunshot pressure wave and trigger a gunshot event. The vehicles transmit a gunshot event report trigger to crowdsourcing server 12. Crowdsourcing server 12 clusters the three individual event triggers to a single event. Crowdsourcing server 12 knows the location and time of the reception of the pressure wave allowing for localization of the source of the pressure wave to be identified. Crowdsourcing server 12 alerts police to the area for further investigation. In a similar way, for instance, the triggering event could be the detection of a gun shot by an external microphone of a vehicle. In this case, the microphone sensor data from all of the nearby vehicles could be used to triangulate the originating point of the gun shot.

Another example of a diverse type of triggering event is a security alarm in an area. In operation, vehicles driving through the area hear the security alarm outputting a loud sound. The vehicles trigger a possible theft event. Crowdsourcing server 12 combines these separate events into one event based on probabilistic modeling and alerts police to the area for further investigation.

Another example of a diverse type of triggering event involves a vehicle parked off on the side of the highway. Vehicles driving on the highway sense the vehicle off to the side of the highway and not moving. The vehicles report to crowdsourced server 12 that there is an abandoned or immobilized vehicle at a specified location, all with unique event tags. Crowdsourcing server 12 clusters the events to a single tag using multimodal probabilistic modeling and reports the parked vehicle to highway patrol.

Another example of a diverse type of triggering event involves traffic violation reporting. The described examples of the diverse type of triggering event are few of the many different triggering events which can be captured by system 10.

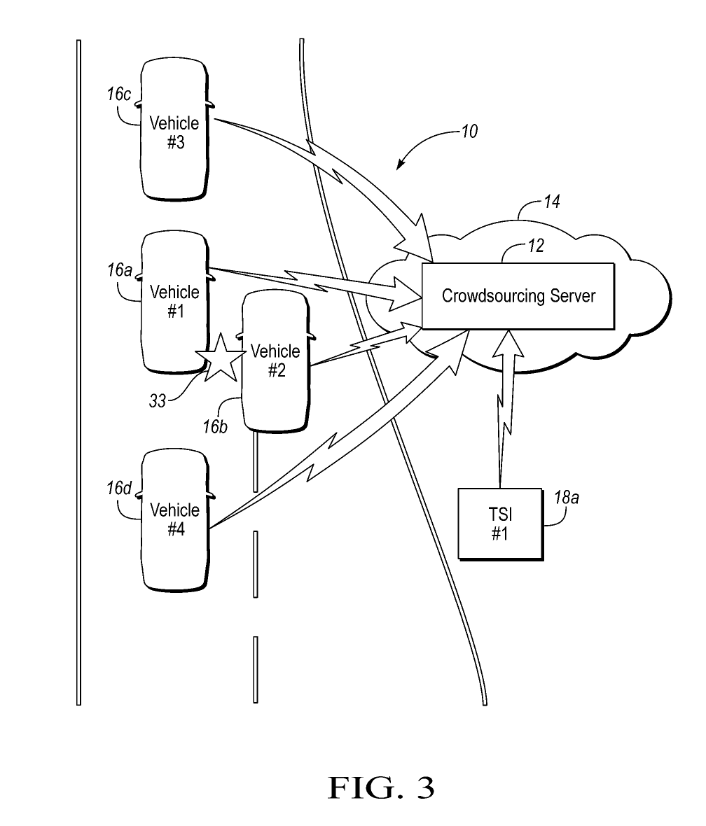

Referring now to FIG. 3, with continual reference to FIGS. 1 and 2, a schematic of system 10 employing vehicles involved in a collision, nearby vehicles, and nearby TSI units is shown. As an example, the vehicles involved in the collision include first and second vehicles 16a and 16b and the vehicles and the TSI units nearby the collision at the time of the collision include third and fourth vehicles 16c and 16d and first TSI unit 18a. As indicated in FIG. 3, first, third, and fourth vehicles 16a, 16c, and 16d are driving down a one lane road and second vehicle 16b is attempting to merge and join the moving traffic.

Second vehicle 16b does not see first vehicle 16a and merges into its path. A collision occurs between first and second vehicles 16a and 16b. First and second vehicles 16a and 16b both broadcast collision alert flags. Crowdsourcing server 12 receives these messages immediately and groups them together based on proximity. First and second vehicles 16a and 16b select relevant sensor data, compress it, and then upload the time range before and after the collision.

The local emergency dispatch receives a notification of the crash and severity information. Severity is calculated by the Restraint Control Module (RCM) which knows the status of air bag deployment. In this example, the severity is reported as low so no emergency responders are requested. Local traffic database gets updated with crash information and automatically monitors area traffic congestion to reroute drivers in the area.

Third and fourth vehicles 16c and 16d receive at least one of the collision alert flags. First TSI unit 18a in the area also gets triggered with at least one of the collision alert flags. Third and fourth vehicles 16c and 16d and TSI unit 18a contact crowdsourcing server 12 which instructs them to start uploading their relevant sensor data. Crowdsourcing server 12 groups all of this sensor data into a unique crash event identifier or with a similar metadata grouping.

Third and fourth vehicles 16c and 16d both have a clear view of the collision with their respective sensor suite. First TSI unit 18a is a traffic camera and it also has a clear view of the collision. Third vehicle 16c has sensor data that includes rear view camera video and rear facing range sensors. Fourth vehicle 16d has sensor data that includes the front-facing camera video, range data from front mounted radar, and a LIDAR map.

The post collision analysis using the crowdsourced data determines that the collision is a low severity event at location X, indicated in FIG. 3 with a star symbol having reference numeral 33. Second vehicle 16b is seen in video crashing into first vehicle 16a while merging into moving traffic. The video from third vehicle 16c shows and sensor data from fourth vehicle 16d indicates that there is no debris in the highway and that the road is safe to drive on. The situation analysis algorithm, such as of crowdsourcing server 12, determines that second vehicle 16b is at fault in this collision. No police officer is required to be sent to the scene to investigate the collision. This operation of system 10 differs from a traditional collision because severity is known immediately from sensor data from the crowd and liability is soon known after post-processing the sensor data.

Techniques that can be used to determine which sensor data is relevant include using different types of clustering to group useful data, and then applying graph theory to determine which of that data is most relevant. A simple trigger based on time and distance to the triggering event can be used to trigger vehicles and TSI units to upload their sensor data to crowdsourcing server 12. This yields all of the sensor data from connected infrastructure and vehicles within a distance of the triggering event within a certain time window of the occurrence of the triggering event. This data set may contain some unnecessary and potentially noisy data. Taking high dimensionality clustering and classification based on multiple sensor parameters and then applying graph theory can be used to filter relevant sensor data and then find the most statistically significant data.

As described, vehicles have an ever increasing sensor suite that includes 360 degree cameras, microphones, radars/range sensors, GPS, and the like. All of these sensors can be useful for understanding subtle nuances of collision events. Vehicle CAN data may be just as important; data such as throttle position, steering inputs and chassis acceleration from multiple vehicles will shed additional light on the event.

Profiles or models can be created on past sensor data to determine whether the driver is a safe or dangerous driver. All of which can be fed into insurance models to more accurately quantify drivers. Insurance claims would be much simpler and easier with recorded video of the event because the possibility of fraud is greatly reduced. Applying sensor fusion on the crowdsourced data from vehicles and connected infrastructure will yield even better data and analytics to make post-crash analysis more accurate and less fraud prone. This disclosure focused on collision events, but system 10 is applicable to any event of which vehicles and/or connected infrastructure are present.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A method comprising:
receiving, by a crowdsourcing server, sensor data from vehicles within a vicinity of a location of an event at a time of the event in response to the vehicles being notified of an occurrence of the event, the sensor data including sensor data of the vehicles sensed at the time of the event.

2. The method of claim 1 wherein:
the sensor data includes sensor data of the vehicles sensed prior to, during, and after the event.

3. The method of claim 1 further comprising:
receiving, by the crowdsourcing server, a notification of the occurrence of the event; and
associating, by the crowdsourcing server, the sensor data with the event.

4. The method of claim 3 further comprising:
reconstructing the event using the sensor data associated with the event.

5. The method of claim 4 further comprising:
notifying, by the crowdsourcing server, a recipient of a reconstructed version of the event.

6. The method of claim 1 further comprising:
receiving, by the crowdsourcing server, sensor data from transportation system infrastructure within the vicinity of the location of the event, the sensor data of the transportation system infrastructure including sensor data of the transportation system infrastructure sensed at the time of the event.

7. The method of claim 1 wherein:
the event does not involve any of the vehicles.

8. The method of claim 1 wherein:
the event is a collision involving at least one of the vehicles.

9. The method of claim 1 further comprising:
notifying the crowdsourcing server of the occurrence of the event; and
upon the crowdsourcing server being notified of the occurrence of the event, triggering, by the crowdsourcing server, the vehicles to provide the sensor data to the crowdsourcing server.

10. A system comprising:
a crowdsourcing server configured to receive sensor data from vehicles within a vicinity of a location of an event at a time of the event in response to the vehicles being notified of an occurrence of the event, the sensor data including sensor data of the vehicles sensed at the time of the event.

11. The system of claim 10 wherein:
the crowdsourcing server becomes configured to receive the sensor data upon the crowdsourcing server being notified of the occurrence of the event.

12. The system of claim 10 wherein:
the crowdsourcing server is further configured to associate the sensor data with the event.

13. The system of claim 12 wherein:
the crowdsourcing server is further configured to reconstruct the event using the sensor data associated with the event.

14. The system of claim 10 wherein:
the crowdsourcing server is further configured to trigger the vehicles to provide the sensor data to the crowdsourcing server upon the crowdsourcing server being notified of the occurrence of the event.

15. A method comprising:
detecting, by a first vehicle, an occurrence of an event;
notifying, by the first vehicle, a crowdsourcing server and other vehicles within a vicinity of the event at a time of the event of the occurrence of the event; and
transmitting, from the other vehicles, sensor data of the other vehicles sensed at the time of the event to the crowdsourcing server.

16. The method of claim 15 further comprising:
transmitting, by the first vehicle, sensor data of the first vehicle sensed at the time of the event to the crowdsourcing server.

17. The method of claim 16 wherein:
the sensor data of a given one of the vehicles includes sensor data indicative of at least one of an external environment of the given one of the vehicles, an operating condition of the given one of the vehicles, and a location of the given one of the vehicles.

18. The method of claim 15 further comprising:
notifying, by the first vehicle, transportation system infrastructure units within the vicinity of the event of the occurrence of the event; and
transmitting, from the transportation system infrastructure units, sensor data of the transportation system infrastructure units sensed at the time of the event to the crowdsourcing server, the sensor data of the transportation system infrastructure units including sensor data indicative of external environments of the transportation system infrastructure units.

19. The method of claim 15 further comprising:
associating, by the crowdsourcing server, the sensor data with the event; and
reconstructing the event using the sensor data associated with the event.

20. The method of claim 15 wherein:
the event is a collision involving one of (i) the first vehicle and none of the other vehicles and (ii) the first vehicle and at least one of the other vehicles.
